(19) United States
(12) Patent Application Publication
(10) Pub. No.: US 2014/0222571 A1
(43) Pub. Date: Aug. 7, 2014

(54) DIRECTING COMMUNICATIONS TO SEMANTIC BUNDLES OF LOCATIONS

(71) Applicant: Google Inc., Mountain View, CA (US)

(72) Inventors: Deepak Chandra, Mountain View, CA (US); Amin Charaniya, Santa Clara, CA (US); Aileen Tang, Mountain View, CA (US); Jyotirmaya Manoj Akkad, San Francisco, CA (US)

(73) Assignee: Google Inc., Mountain View, CA (US)

(21) Appl. No.: 14/143,670

(22) Filed: Dec. 30, 2013

Related U.S. Application Data
(60) Provisional application No. 61/761,038, filed on Feb. 5, 2013.

(51) Int. Cl. G06Q 30/02

(52) U.S. Cl. CPC G06Q 30/0261
USPC 705/14.58

(57) ABSTRACT

A system and a computer-implemented method of serving online content items using a semantic description of a feature that is common to a plurality of online content locations are provided. The method includes assigning one or more identifications based on the semantic descriptions to each of the plurality of online content locations using one or more features associated with a respective one of the online content locations, receiving a selection of one or more of the assigned identifications and a physical location of the associated online content locations, determining at least one of a physical location of an online content recipient, and an intended location of the online content recipient, and transmitting an online content item to the online content recipient when the online content recipient is within a specified distance from any of the selected online content locations.

### CROSS REFERENCE TO RELATED APPLICATIONS

This application claims priority to and the benefit of the filing date of U.S. Provisional Application No. 61/761,038 filed on Feb. 5, 2013, which is hereby incorporated by reference in its entirety.

### BACKGROUND

This description relates to content serving, and, more particularly, to a network-based method and system for selecting online content recipients using semantic location specification.

At least some known content serving systems permit online content providers to hand-pick geographical regions of various levels, up to, for example, but not limited to, a postal code, for directing communications in their advertising campaigns. As the number of geographical regions and venues in those regions that are available increase it will be difficult for online content providers to know all the available online content venues by the name of the venue, nor will it be possible to expose all these new venues individually to online content provider 102. Moreover, a privacy of users is of concern, when allowing online content providers to direct communications to very small geographical regions, for example, regions of less than one kilometer squared, and regions having a very small population. To comply with privacy concerns and regulations, the user data may be maintained in an anonymous manner and may not include personally identifiable information as described herein.

### BRIEF DESCRIPTION

In one embodiment, a computer-implemented method of serving online content items using a semantic description of a feature that is common to a plurality of online content locations includes assigning one or more identifications based on the semantic descriptions to each of the plurality of online content locations using one or more features associated with a respective one of the online content locations, receiving a selection of one or more of the assigned identifications and a physical location of the associated online content locations, determining at least one of a physical location of an online content recipient, and an intended location of the online content recipient, and transmitting an online content item to the online content recipient when the online content recipient is within a specified distance from any of the selected online content locations.

In another embodiment, an online content item serving system using semantic descriptions of a feature that is common to a plurality of online content locations includes a processor and a computer-readable storage device having encoded thereon computer readable instructions that when executed by the processor cause the processor to assign one or more identifications based on the semantic descriptions to each of the plurality of online content locations using one or more features associated with a respective one of the online content locations, receive a selection of one or more of the assigned identifications and a physical location of the associated online content locations, determine at least one of a physical location of an online content recipient, and an intended location of the online content recipient, and transmit an online content item to the online content recipient when the online content recipient is within a specified distance from any of the selected online content locations.

In yet another embodiment, a computer-readable storage device having computer-executable instructions embodied thereon, wherein when executed by at least one processor, the computer-executable instructions cause the processor to assign one or more identifications based on the semantic descriptions to each of the plurality of online content locations using one or more features associated with a respective one of the online content locations, receive a selection of one or more of the assigned identifications and a physical location of the associated online content locations, determine at least one of a physical location of an online content recipient, and an intended location of the online content recipient, and transmit an online content item to the online content recipient when the online content recipient is within a specified distance from any of the selected online content locations.

In another aspect, a computer system for serving online content using a semantic description of a feature that is common to a plurality of online content locations includes means for assigning one or more identifications based on the semantic descriptions to each of the plurality of online content locations using one or more features associated with a respective one of the online content locations. The computer system also includes means for receiving a selection of one or more of the assigned identifications and a physical location of the associated online content locations and determining at least one of a physical location of an online content recipient, and an intended location of the online content recipient. The computer system also includes means for transmitting an online content item to the online content recipient when the online content recipient is within a specified distance from any of the selected online content locations.

The computer system also includes means for categorizing the online content locations using at least one of a physical location of an online content recipient, and an intended location of the online content recipient. The computer system also includes means for categorizing the online content locations as particular types wherein the types include at least one of local listings, landmarks, and demographics. The computer system also includes means for determining the specified distance using a geo-serving system to determine a distance between the at least one of a physical location of an online content recipient and an intended location of the online content recipient and any of the selected online content locations.

The computer system also includes means for determining an intended location of the online content recipient using a destination of a search request requested by the online content recipient. The computer system also includes means for matching a categorized online content locations type with a navigation search request term requested by the online content recipient.

### BRIEF DESCRIPTION OF THE DRAWINGS

FIGS. 1-7 show example embodiments of the method and system described herein.

FIG. 1 is a schematic block diagram of an online content environment in accordance with an example embodiment of the present disclosure.

FIG. 2 illustrates an example data flow within the environment shown in FIG. 1.

FIG. 3 is a flowchart of a method of serving content using a semantic description of a feature that is common to a plurality of online content locations.

FIG. 4 is a table illustrating example features that may be used with the online content item serving system shown in FIG.1.

FIG. 5 is a diagram of example computing devices and that may be used in the environment shown in FIG. 1.

FIG. 6 is a screen capture of an online content provider interface in accordance with an example embodiment of the present disclosure.

FIG. 7 is a screen capture of online content provider interface in accordance with an example embodiment of the present disclosure.

FIG. 8 is a diagram of components of one or more example computing devices that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description illustrates embodiments of the disclosure by way of example and not by way of limitation. It is contemplated that the disclosure has general application to determining online content locations using semantic descriptions of a feature that is common to a plurality of online content locations in industrial, commercial, and residential applications. As used herein, semantic descriptions refers to selecting geolocations based on attributes of the geolocations, for example, selecting “all postal codes with median income>200K in the US.” Semantic descriptions also refers to selecting geolocations that are more granular than, for example, postal codes, such as, but, not limited to geolocations specified by their attributes, for example, “all malls in California”, “all airports in the US,” etc. Semantic descriptions also refers to selecting geolocations about a location extension within a selectable radius.

As the number of geographical regions and venues that are available to online content providers 102 for directed communications increase it will be difficult for online content providers 102 to know all the available venues by the name of the venue, and to expose all these new geographical regions and venues individually to online content provider 102. To ease the burden on online content providers 102 in selecting the geographical regions and venues that they would like to direct communications, online content providers 102 can select desired regions and venues by a description of what types of regions and venues to direct communications rather than having to know all of the regions and venues by their name. A more intuitive and dynamic way of directing communications for online content providers 102, where, management overhead of geographical regions and venues for online content provider 102 is minimal and online content providers 102 are presented with more granular, accurate and up-to-date venues like malls, airports, even electronic stores and coffee shops with appropriate privacy protection for the end user is described herein. Embodiments of the present disclosure permit directing communications to regions and venues by their attributes and wrapping a distance measure around location extensions within semantic selection rules. Directing communications to geographical regions selected by their attributes permits directing communications to geographical regions that are already available and that minimizes the need for individually selecting them based on criteria, for example, “[a]ll postal codes with population density>2000 people per square mile in the US”. Moreover, directing communications to geographical regions by their attributes would also permit directing communications to new geographical regions more granular than postal codes by their attributes, for example, “All malls in California”, “All airports in the US” etc., or “A one mile radius around all tourist locations in San Francisco.”

The following description refers to the accompanying drawings, in which, in the absence of a contrary representation, the same numbers in different drawings represent similar elements.

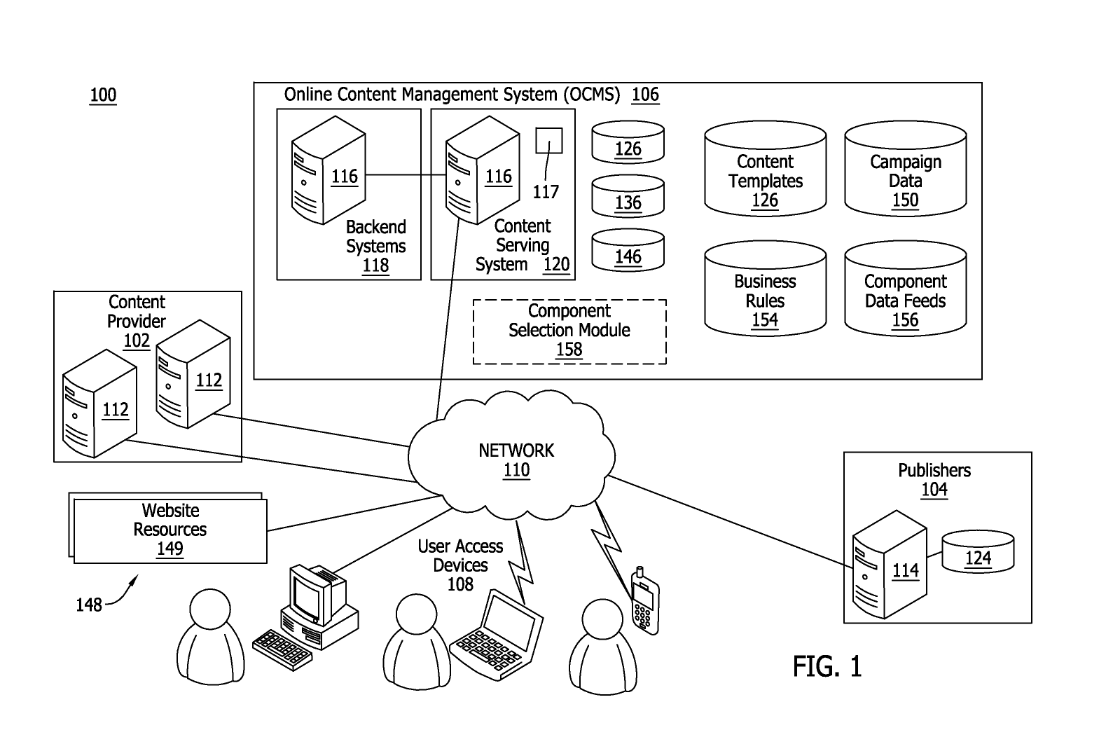

FIG. 1 is a schematic block diagram of an online content environment 100 in accordance with an example embodiment of the present disclosure. In the example embodiment, online content environment 100 may include one or more online content providers 102, one or more publishers 104, an online content management system (OCMS) 106, and one or more user access devices 108, which may be coupled to a network 110. Each of the elements 102, 104, 106, 108 and 110 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an online content distribution network. While reference is made to distributing online content, environment 100 can be suitable for distributing other forms of content including other forms of sponsored content.

Online content providers 102 may include any entities that are associated with online content or advertisements (“ads”). As used herein, online content refers to any form of communication regarding an item. An advertisement or an “ad” refers to any form of communication in which one or more products, services, ideas, messages, people, organizations or other items are identified and promoted (or otherwise communicated). Content is not limited to commercial promotions or other communications. An online content item may be a public service announcement or any other type of notice, such as a public notice published in printed or electronic press or a broadcast. An online content item may be referred to or include sponsored content.

Online content may be communicated via various mediums and in various forms. In some examples, online content may be communicated through an interactive medium, such as the Internet, and may include graphical content (e.g., banner ads), textual ads, image ads, audio ads, video ads, ads combining one of more of any of such components, or any form of electronically delivered online content. Content may include embedded information, such as embedded media, links, meta-information, and/or machine executable instructions. Content could also be communicated through RSS (Really Simple Syndication) feeds, radio channels, television channels, print media, and other media.

The term “ad” or “online content item” can refer to both a single “creative” and an “ad group.” A creative refers to any entity that represents one ad impression. An ad impression refers to any form of presentation of an ad or online content item such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

Online content providers 102 may provide (or be otherwise associated with) products and/or services related to content. Online content providers 102 may include or be associated with, for example, retailers, wholesalers, warehouses, manufacturers, distributors, health care providers, educational establishments, financial establishments, technology providers, energy providers, utility providers, or any other product or service providers or distributors.

Online content providers 102 may directly or indirectly generate maintain, review and/or analyze content, which may be related to products or services offered by or otherwise associated with online content providers 102. Online content providers 102 may include or maintain one or more data processing systems 112, such as servers or embedded systems, coupled to the network 110. Online content providers 102 may include or maintain one or more processes that run on one or more data processing systems.

Publishers 104 may include any entities that generate, maintain, provide, present and/or otherwise process content in the environment 100. “Publishers,” in particular, includes authors of online content, wherein authors may be individual persons, or, in the case of works made for hire, the proprietor(s) who hired the individual(s) responsible for creating the online content. The term “content” refers to various types of web-based and/or otherwise presented information, such as articles, discussion threads, reports, analyses, financial statements, music, video, graphics, search results, web page listings, information feeds (e.g., RSS feeds), television broadcasts, radio broadcasts, printed publications, etc.

In some implementations, publishers 104 may include content providers with an Internet presence, such as online publication and news providers (e.g., online newspapers, online magazines, television websites, etc.), online service providers (e.g., financial service providers, health service providers, etc.,), and the like. The publishers 104 can include television broadcasters, radio broadcasters, satellite broadcasters, and other content providers. One or more of the publishers 104 may represent a content network that is associated with OCMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with content that is related or relevant to the retrieved content for display to users. As discussed further below, this relevant content may be provided from OCMS 106 and be combined with content for display to users. In some examples, the publishers 104 may retrieve content for display on a particular user access device 108 and then forward the content to the user access device 108 along with code that causes one or more content from OCMS 106 to be displayed to the user. In other examples, the publishers 104 may retrieve content, retrieve one or more relevant content items (e.g., from OCMS 106 or online content providers 102), and then integrate the content and the article to form a content page for display to the user.

As noted above, one or more of the publishers 104 may represent a content network. In such an implementation, online content providers 102 may be able to present content to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

OCMS 106 manages content and provides various services to online content providers 102, the publishers 104, and the user access devices 108. OCMS 106 may store content in an online content repository 136 and facilitate the distribution or selective provision and recommendation of content through the environment 100 to the user access devices 108. In some configurations, OCMS 106 may include or access functionality associated with other online content systems.

OCMS 106 may include one or more data processing systems 116, such as servers or embedded systems, coupled to the network 110. It can also include one or more processes, such as server processes. In some examples, OCMS 106 may include an online content serving system 120 comprising one or more processors 117 and one or more backend processing systems 118. Online content serving system 120 may include one or more data processing systems 116 and may perform functionality associated with delivering content to publishers or user access devices. The backend processing systems 118 may include one or more data processing systems 116 may perform functionality associated with identifying relevant content to deliver, processing various rules, performing filtering processes, generating reports, maintaining accounts and usage information, and other backend system processing. OCMS 106 can use the backend processing systems 118 and online content serving system 120 to selectively recommend and provide relevant content from online content providers 102 through the publishers 104 to the user access devices 108.

OCMS 106 may include one or more interface or frontend modules for providing the various features to online content providers 102, publishers, and user access devices. For example, OCMS 106 may provide one or more publisher front-end interfaces (PFEs) for allowing publishers to interact with OCMS 106. OCMS 106 may also provide one or more online content provider front-end interfaces (AFEs) for allowing online content providers 102 to interact with OCMS 106. In some examples, the front-end interfaces may be configured as web applications that provide users with network access to features available in OCMS 106.

OCMS 106 provides various online content management features to online content providers 102. OCMS 106 online content features may allow users to set up user accounts, set account preferences, create content, select keywords for content, create campaigns or initiatives for multiple products or businesses, view reports associated with accounts, analyze costs and return on investment, selectively identify customers in different regions, selectively recommend and provide content to particular publishers, analyze financial information, analyze online content performance, estimate ad traffic, access keyword tools, add graphics and animations to content, etc.

OCMS 106 may allow online content providers 102 to create content and input keywords for which those content will appear. In some examples, OCMS 106 may provide content to user access devices or publishers when keywords associated with the content are included in a user request or requested content. OCMS 106 may also allow online content providers 102 to set bids for content placement. A bid may represent the maximum amount an online content provider is willing to pay for each ad impression, user click-through of an online content item or other interaction with an online content item. A click-through can include any action a user takes to select an online content item. Online content providers 102 may also choose a currency and monthly budget.

OCMS 106 may also allow online content providers 102 to view information about ad impressions, which may be maintained by OCMS 106. OCMS 106 may be configured to determine and maintain the number of ad impressions relative to a particular website or keyword. OCMS 106 may also determine and maintain the number of click-throughs for an online content item as well as the ratio of click-throughs to impressions.

OCMS 106 may allow online content providers 102 to input description information associated with content. This information could be used to assist the publishers 104 in determining which content to publish. Online content providers 102 may additionally input a cost/value associated with selected conversion types, such as a five dollar credit to the publishers 104 for each product or service purchased.

OCMS 106 may provide various features to the publishers 104. OCMS 106 may deliver content (associated with online content providers 102) to the user access devices 108 when users access content from the publishers 104. OCMS 106 can be configured to deliver content items that are relevant to publisher sites, site content and publisher audiences.

OCMS 106 may allow the publishers 104 to search and select specific products and services as well as associated content to be displayed with content provided by the publishers 104. For example, the publishers 104 may search through content in the online content repository 136 and select certain content for display with their content.

OCMS 106 may be configured to selectively recommend and provide online content items created by online content providers 102 to the user access devices 108 directly or through the publishers 104. OCMS 106 may selectively recommend and provide online content items to a particular publisher 104 (as described in further detail herein) or a requesting user access device 108 when a user requests search results or loads content from the publisher 104.

The user access devices 108 may include any devices capable of receiving information from the network 110. The user access devices 108 could include general computing components and/or embedded systems optimized with specific components for performing specific tasks. Examples of user access devices 108 include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

Environment 100 further includes a website 148 including one or more resources 149 (e.g., text, images, multimedia content, and programming elements, such as scripts) associated with a domain name and hosted by one or more servers. Resources 149 can be relatively static (e.g., as in a publisher's webpage) or dynamically generated in response to user query (e.g., as in a search engine's result page).

User devices 108 can request resources 149 from a website 148. In turn, build data representing the resource 149 can be provided to the user access device 108 for presentation by the user access device 108. The build data representing the resource 149 can also include data specifying an online content slot in which online content can be presented.

When a resource 149 is requested by a user access device 108, the online content management system 106 receives a request for online content to be provided with the resource 149. The request for online content can include characteristics of the online content slots (e.g., size, web address of the resource, media type of the requested online content, etc.) that are defined for the requested resource or search results page, and can be provided to the online content management system 106.

Based on data included in the request for online content, the online content management system 106 can identify online content that are eligible to be provided in response to the request. For example, eligible online content can have characteristics matching the characteristics of available online content slots and have online content serving keywords that match the specified resource keywords or search queries.

Each online content provider 102 can create one or more advertising campaigns using various campaign parameters that are used to control distribution of online content. Each advertising campaign can include one or more ad groups that have modified campaign parameters that are specific to the ad group. Examples of campaign parameters can include online content serving keywords and corresponding bids, geographic or other factors used to facilitate online content serving, delivery period, content network, keyword match type, as well as other parameters corresponding to one or more online content items. The campaign data can be stored in the campaign data store 150. OCMS 106 can retrieve the information in the campaign data store 150 when preparing a response to an online content request.

Parameters related to an online content item can include, for example, creative identifier, creative name, creative type, size, first line, web address of the landing page, display URL, media type, and so on. One of the creative types that an online content provider 102 can specify for an online content item is the dynamic online content type. Online content provider 102 can provide an online content item template as the creative, and the online content item template can be selected (e.g., in the same manner as other types of creatines) to fulfill a received online content item request for an available online content slot. When an online content item template (or in other words, a dynamic ad creative) is selected to fulfill an online content item request, a dynamic online content item can be generated on-the-fly based on the online content item template to fulfill the online content item request.

The online content item template can specify the general appearance, such as an invariable portion of the content and some aspects of the appearance and format of the dynamic ad. The invariable portion of the content and aspects of the dynamic online content item remains the same across multiple dynamic online content items generated using the same online content item template.

In addition to specifying the invariable portion of the dynamic ad, the online content item template also leaves some content or aspects of format and appearance of the dynamic online content item unspecified. Instead, the online content item template can specify one or more component slots which prescribe the requirements for data items (or components) that can be used to provide the unspecified content and aspects of format and appearance to complete the dynamic ad. Components having component characteristics (e.g., content, structural format, function, or other attributes) that satisfy the requirements of the component slots can be selected and inserted into the component slots to complete the dynamic ad. In some implementations, the online content item templates can also specify how a selected component is applied to the component slot, such as the size, font, color, position, etc. of the selected component as the component appears in the dynamic ad.

Online content providers 102 can specify multiple dynamic online content item creatives or online content item templates for use in their ad campaigns. The online content item templates can be stored along with other creatives (e.g., static image ads, video ads, text ads, etc.) in the campaign data store 150. In some implementations, the online content item templates can be stored separately from the other types of creatives, for example, in an online content item template data store 152. Individual online content item templates can be retrieved by OCMS 106 by the templates' creative IDs.

OCMS 106 can have access to a large number of available components of various types, for example, through a component data feed store 156. The components can have varying content. The component data feed store 156 can be provided and updated by online content provider 102 from time to time. In some implementations, the component data feed store 156 can be linked to product catalogs or other business data stores of online content provider 102, such that real-time data can be made available to OCMS 106 without active intervention by online content provider 102.

OCMS 106 can select components from among the large number of components available in the component data feed store 156. OCMS 106 can also apply the selected components to the component slots in a dynamic online content item according to the specifications in an online content item template selected from the online content item template data store 152. Once the dynamic online content item is constructed using the selected components, the dynamic online content item can be provided by online content management system 106 to fulfill the received online content item request. In some implementations, a component selection module 158 can be implemented to carry out actions related to component selection. The component selection module 158 can be part of OCMS 106 or a standalone module in communication with OCMS 106.

When online content management system 106 selects components for the selected online content item template in response to a received online content item request, online content management system 106 observes the business rules including the co-occurrence constraints specified for the selected online content item template. The business rules can be specified by online content provider 102 through an interface provided by online content management system 106. The business rules can be stored in the campaign data store along with other campaign data. Alternatively, the business rules can be stored in a business rule data store 154 apart from other types of campaign data. The business rules can be campaign specific, ad group specific, or online content item template specific, for example.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed online content providers 102, publishers 104 and/or user access devices 108, which may be discrete, integrated modules or distributed systems. Similarly, the environment 100 is not limited to a single OCMS 106 and may include any number of integrated or distributed OCMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

Online content provider 102 can specify parameters of advertising campaigns and online content through OCMS 106. OCMS 106 can receive online content item requests from user devices and select online content items according to information in the online content item requests and the parameters of the advertising campaigns. The online content items that are delivered can include dynamically generated online content items as described above.

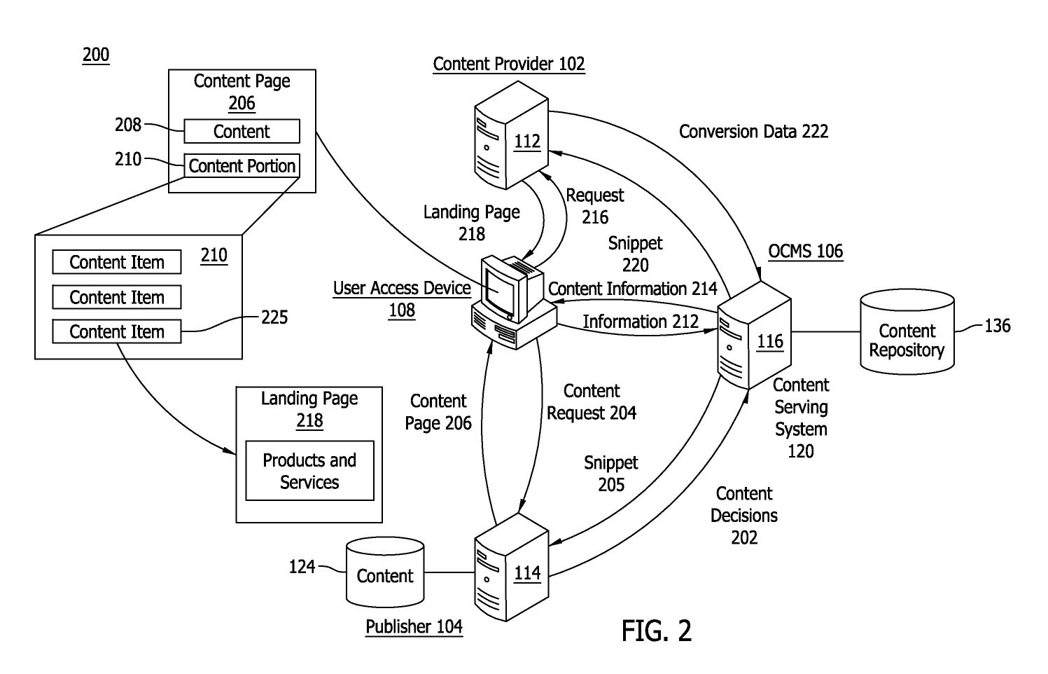

FIG. 2 illustrates an example data flow 200 within environment 100 (shown in FIG. 1). In the data flow 200, OCMS 106 stores online content items from online content providers 102 and receives online content item decisions 202 from a particular publisher 104. Online content item decisions 202 can include decisions to approve and/or disapprove certain online content items and/or online content providers 102. These online content item decisions 202 can be based on aggregated ratings or scores, associated with online content/online content providers 102 that are provided to the publisher 104 by OCMS 106. Such aggregated scores can represent ratings of online content/online content providers 102 received from multiple publishers 104.

During the data flow 200, the publisher 104 may receive a content request 204 from a particular user access device 108. The content request 204 may, for example, include a request for a web document on a given topic (e.g., automobiles). In response to the content request 204, the publisher 104 may retrieve relevant content (e.g., an automobile article) from the content repository 124 or some other source.

The publisher 104 may respond to the content request 204 by sending a content page 206 or other presentation to the requesting user access device 108. The content page 206 may include the requested content 208 (e.g., the automobile article) as well as a code “snippet” 205 associated with an ad. A code “snippet” refers, for example, to a method used by one device (e.g., a server) to ask another device (e.g., a browser running on a client device) to perform actions after or while downloading information. In some examples, a code “snippet” may be implemented in JAVASCRIPT® code or may be part of HTML (Hypertext Markup Language) or other web page markup language or content.

OCMS 106 may provide the code snippet 205 to the publisher 104 and/or the user access device 108. The code snippet can originate and/or be provided from other sources. As the requesting user access device 108 loads the content page 206, the code snippet 205 causes the user access device 108 to contact OCMS 106 and receive additional code (e.g., JAVASCRIPT® or the like), which causes the content page 206 to load with an online content item portion 210.

Online content item portion 210 may include any element that allows information to be embedded within the content page 206. In some examples, online content item portion 210 may be implemented as an HTML element, such an I-Frame (inline frame) or other type of frame. Online content item portion 210 may be hosted by OCMS 106 or the publisher 104 and may allow content (e.g., ads) from OCMS 106 or the publisher 104 to be embedded inside the content page 206. Parameters associated with online content item portion 210 (e.g., its size and shape) can be specified in the content page 206 (e.g., in HTML), so that the user access device 108 can present the content page 206 while online content item portion 210 is being loaded. Other implementations of online content portion 210 may also be used.

Online content item portion 210 may send OCMS 106 formatting and content information 212. This information 212 may include information describing the manner (e.g., how, when, and/or where) in which online content items can be rendered by the user access devices 108. The information 212 may also include online content attributes and parameters, such as size, shape, color, font, presentation style (e.g., audio, video, graphical, textual, etc.), etc. The information 212 may also specify a quantity of online content items desired.

The formatting and content information 212 can include information associated with the requested content 208 displayed in content page 206. Such information may include a URL associated with the requested content page 206. The information 212 can include the requested content itself, a category corresponding to the requested content or the content request, part or all of the content request 204, content age, content type (e.g., text, graphics, video, audio, mixed media, etc.), geo-location information, and the like.

In response to the information 212, OCMS 106 may provide the user access device 108 with online content information 214. Online content item information 214 may include one or more online content items 225 for placement in online content item portion 210 of the content page 206. Online content item information 214 may also include a signed or encoded specification of an ad.

Online content item information 214 may include online content items that are relevant to user interest. OCMS 106 may retrieve and provide relevant online content items based on the information 212 received from the user access device 108. OCMS 106 may retrieve online content item information 214 from online content repository 136 using the backend processing systems 118. OCMS 106 may retrieve relevant online content items using information from a crawling module, various keywords, various statistical associations between online content items and content, and/or preference information associated with the publishers.

OCMS 106 may decide whether to serve certain online content items with publisher content based on online content item decision 202 received from the publisher 104. For example, OCMS 106 may identify a relevant online content from online content repository 136 based on keywords but may decide that online content item should not be served with the publisher content (e.g., the requested automobile document) because the publisher 104 has indicated in online content item decisions 202 a disapproval of the identified ad. In some examples, these online content serving decisions 202 may be based on rules maintained by the backend processing systems 118.

Online content item portion 210 may populate with online content items included in online content item information 214, such as online content items 225. Online content item portion 210 and the displayed online content items 225 may occupy a portion of the content page 206, which may be distinct from other content (e.g., the requested content 208) in the content page 206.

When a user clicks on the displayed online content item 225, an embedded code snippet may direct the user access device 108 to contact OCMS 106. During this event, the user access device 108 may receive an information parcel, such as a signed browser cookie, from OCMS 106. This information parcel can include information, such as an identifier of the selected online content item 225, an identifier of the publisher 104, and the date/time online content item 225 was selected by the user. The information parcel may facilitate processing of conversion activities or other user transactions.

The user access device 108 may then be redirected to online content provider 102 associated with the selected online content item 225. The user access device 108 may send a request 216 to the associated online content provider 102 and then load a landing page 218 from online content provider 102. The user may then perform a conversion action at the landing page 218, such as purchasing a product or service, registering, joining a mailing list, etc. A code snippet 220, which may be provided by OCMS 106, may be included within a conversion confirmation page script, such as a script within a web page presented after the purchase. The user access device 108 may execute the code snippet 220, which may then contact OCMS 106 and report conversion data 222 to OCMS 106. The conversion data 222 may include conversion types and numbers as well as information from cookies. The conversion data 222 may be maintained in the conversion data repository 136.

FIG. 2 is an example only and not intended to be restrictive. Other data flows may therefore occur in the environment 100 and, even with the data flow 200, the illustrated events and their particular order in time may vary. Further, the illustrated events may overlap and/or may exist in fewer steps. Moreover, certain events may not be present and additional and/or different events may be included.

In alternative data flows, OCMS 106 can allow online content providers 102 to approve publishers in a manner similar to the manner in which publishers approve online content providers 102. In such data flows, OCMS 106 can receive publisher decisions (i.e., decisions about publishers) from one or more online content providers 102. The publisher decisions made by online content providers 102 can include approvals and disapprovals of certain publishers. These approval/disapproval decisions can be based on aggregated scores, associated with publishers that are provided to online content providers 102. The aggregated scores can represent ratings of publishers received from multiple online content providers 102. When providing relevant online content items to the user access devices 108, OCMS 106 may take into account these publisher approvals/disapprovals. For example, OCMS 106 may decide to not provide an otherwise relevant online content item to a given publisher based on an online content provider's disapproval of that publisher. Not providing a relevant online content item to a publisher can include not bidding in an auction for publisher online content item space.

In alternative data flows, the publisher 104 can send an online content item request to OCMS 106 prior to sending a content page to the user access device 108. OCMS 106 may respond by sending relevant online content items to the publisher 104. The publisher 104 may combine the received online content items with requested content in the content page and then send the content page, including the online content item portion 210, to the user access device 108 for display to a user.

In alternative data flows, OCMS 106 may selectively recommend and provide online content items to the user access devices 108 based on search terms provided by the user access devices 108. In these dataflows, OCMS 106 may provide searching services and receive search terms directly from the user access devices. OCMS 106 can also receive search terms from a dedicated searching system that receives user search requests. OCMS 106 may selectively recommend and provide online content items to the user access devices based on the received search terms and online content item keywords provided by online content providers 102. Other modifications to the data flow 200 are also possible.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined Thus, the user may have control over how information is collected about the user and used by a content server.

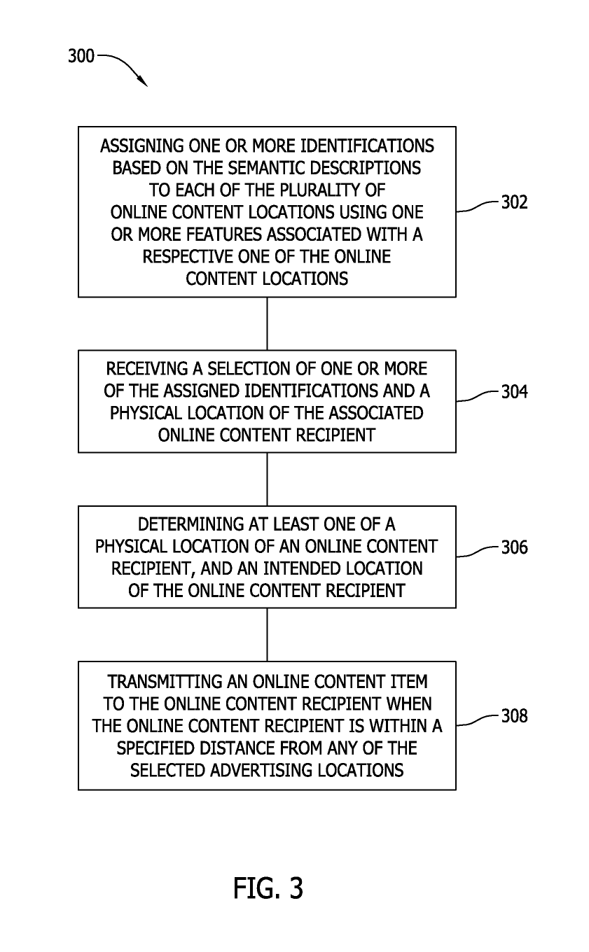

FIG. 3 is a flowchart of a method 300 of serving online content items using a semantic description of a feature that is common to a plurality of online content locations. In the example embodiment, method 300 includes assigning 302 one or more identifications based on the semantic descriptions to each of the plurality of online content locations using one or more features associated with a respective one of the online content locations and receiving 304 a selection of one or more of the assigned identifications and a physical location of the associated online content locations. Method 300 also includes determining 306 at least one of a physical location of an online content recipient, and an intended location of the online content recipient and transmitting 308 an online content item to the online content recipient when the online content recipient is within a specified distance from any of the selected online content locations.

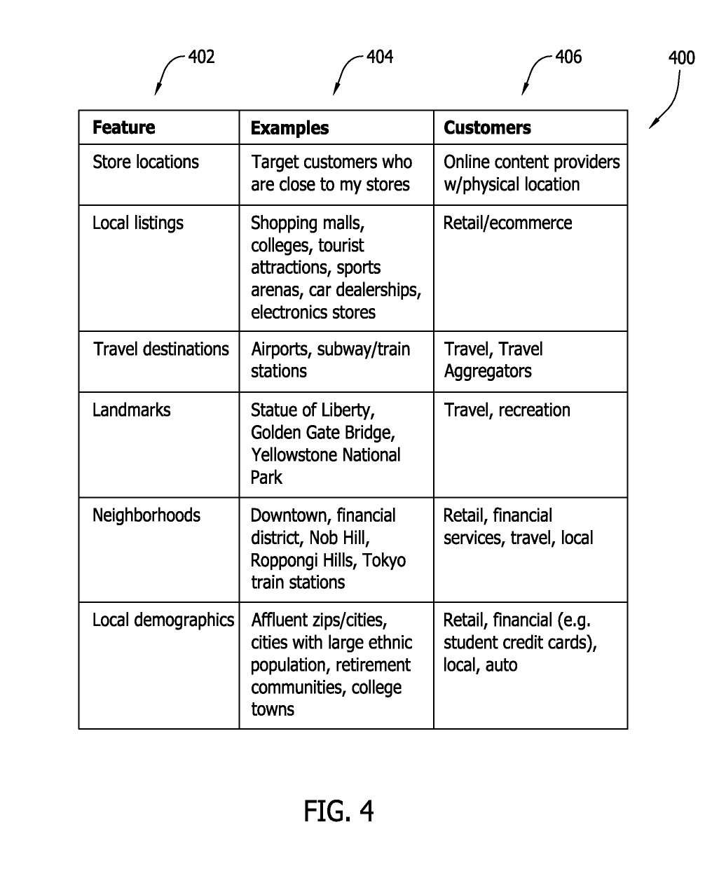

FIG. 4 is a table 400 illustrating example features that may be used with online content item serving system 120 (shown in FIG. 1). In the example embodiment, table 400 includes a column 402 listing available features for use in categorizing online content locations, a column 404 listing examples of the type of location that would be categorized in a respective feature, and a column 406 listing likely customers that would be online content recipients in those types of locations. In various embodiments, an online content provider 102 wanting to transmit online content items to recipients that may be at or intending to travel to any of a plurality of landmarks within a selectable area does not need to list each and every landmark in the selectable area, but rather only needs to specify ‘landmarks’ in an online content item specification and online content serving system 120 will already have categorized all of the landmark type locations in the selectable area into the ‘landmarks’ feature identification.

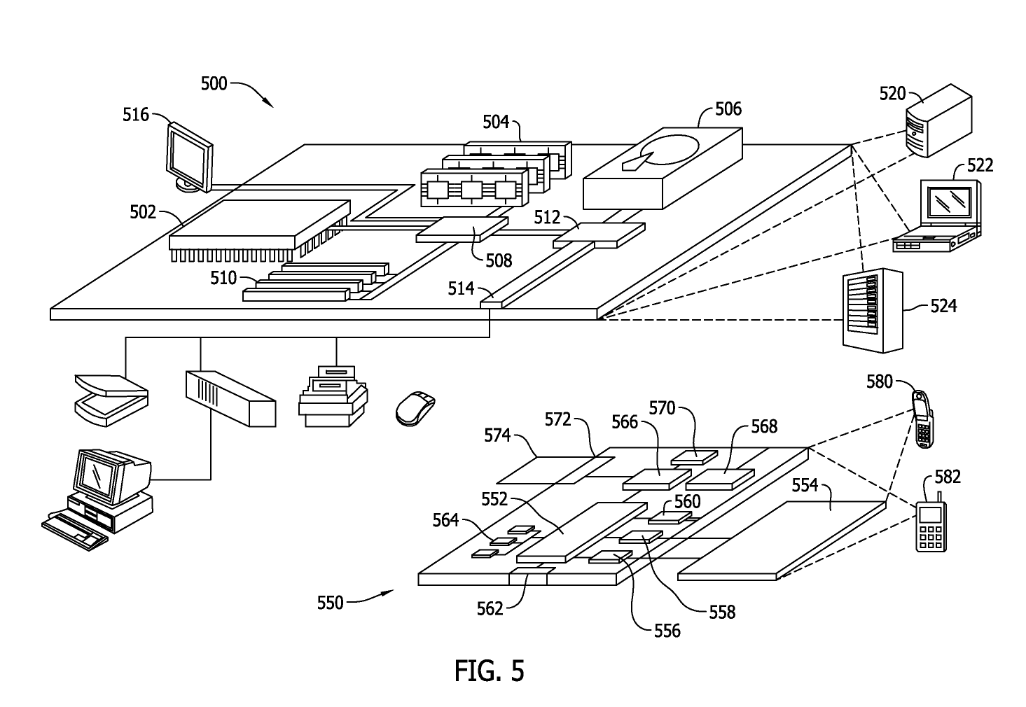

FIG. 5 is a diagram of example computing devices 500 and 550 that may be used in the environment shown in FIG. 1. More specifically, FIG. 5 shows an example of a generic computing device 500 and a generic mobile computing device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be examples only, and are not meant to limit implementations of the embodiments described and/or claimed in this document.

Computing device 500 includes a processor 502, a memory 504, a storage device 506, a high-speed interface/controller 508 connecting to memory 504 and high-speed expansion ports 510, and a low speed interface/controller 512 connecting to a low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed buss 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as computing device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The computing device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the computing device 550, such as control of user interfaces, applications run by computing device 550, and wireless communication by computing device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of computing device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to computing device 550 through expansion interface 572, which may include, for example, a SIMM (Single In-Line Memory Module) card interface. Such expansion memory 574 may provide extra storage space for computing device 550, or may also store applications or other information for computing device 550. Specifically, expansion memory 574 may include instructions to carry out or supplement the processes described above, and may include secure information also. Thus, for example, expansion memory 574 may be provide as a security module for computing device 550, and may be programmed with instructions that permit secure use of computing device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Computing device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning system) receiver module 570 may provide additional navigation- and location-related wireless data to computing device 550, which may be used as appropriate by applications running on computing device 550.

Computing device 550 may also communicate audibly using audio codec 560, which may receive spoken information from a user and convert it to usable digital information. Audio codec 560 may likewise generate audible sound for a user, such as through a speaker, e.g., in a handset of computing device 550. Such sound may include sound from voice telephone calls, may include recorded sound (e.g., voice messages, music files, etc.) and may also include sound generated by applications operating on computing device 550.

The computing device 550 may be implemented in a number of different forms, as shown in the figure. For example, it may be implemented as a cellular telephone 580. It may also be implemented as part of a smart phone 582, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable storage device,” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 500 and 552 are configured to receive and/or retrieve data pertaining to the creation, review and revision of online content items; data regarding online content providers 102, online content links or impressions corresponding to those online content providers 102 that appear on a web page, and metrics corresponding to the appearance of those impressions on that web page, etc., from various other computing devices connected to computing devices 500 and 552 through a communication network, and store this data within at least one of memory 504, storage device 506, and memory 564. Computing systems 500 and 552 are further configured to manage and organize the data within at least one of memory 504, storage device 506, and memory 564 using the techniques described herein.

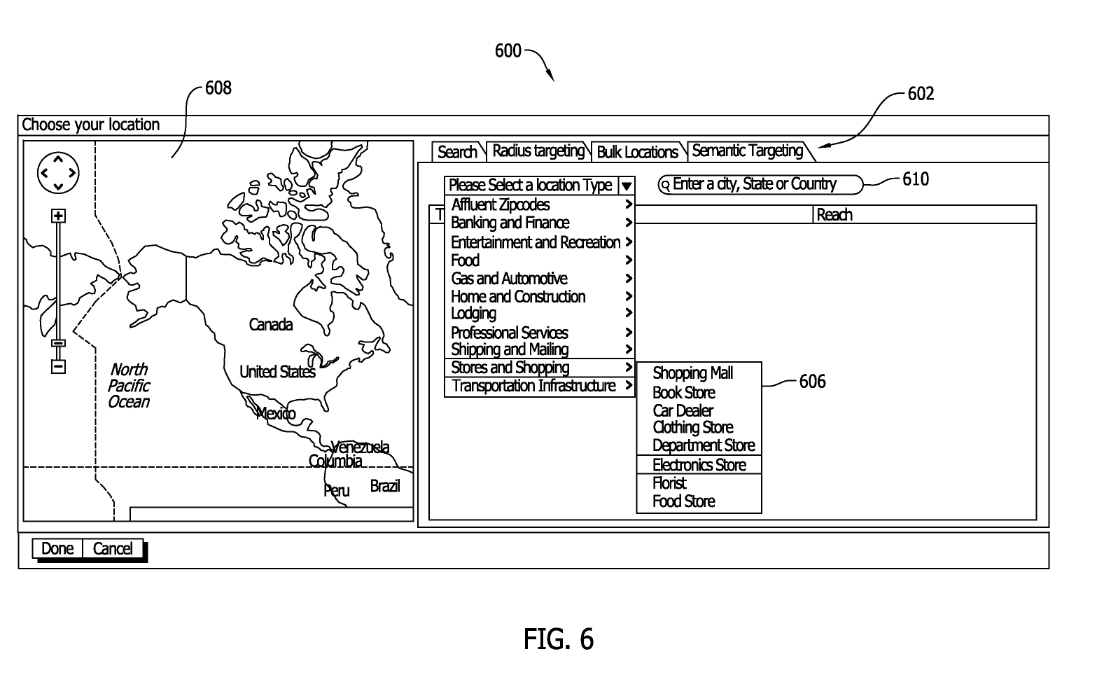

FIG. 6 is a screen capture of an online content provider interface 600 in accordance with an example embodiment of the present disclosure. In the example embodiment, interface 600 includes a plurality of tabs for selecting types of locations for transmitting online content items. Such locations are those where desirable online content recipients are likely to be located. The location of online content recipients may be a current location of the online content recipient, a future location of the online content recipient based on the results of a search requested by the online content recipient that includes a destination location either in the search request or the results of the request, or a future location of the online content recipient based on a path determined from the results of a directions search to a destination requested by the online content recipient. Any of the locations of the online content recipient may be determined from a GPS signal, cell tower positions, a manual input by the user, or other location determination.

Interface 600 includes a dropdown selection box 604 permitting the user to select from a broad category of types of locations, including, for example, but not limited to, banking and finance institutions, zip codes based on demographic indicators, lodging, and stores and shopping locations. Each type may have sub-types 606 associated with the type. For example, the stores and shopping type may have sub-types that include but not limited to, shopping mall, bookstore, clothing store, and food store. When selected, online content items of online content provider 102 are transmitted to online content locations fitting those types and subtypes selected and within a selected radius of a geographical region selected for directed communications. A map area 608 permits selection of a location and/or radius of a point from which to determine the locations specified by the type selection. A search box 610 may also be used to specify a location by, but not limited to, a place name, a landmark name, an address and/or zip code, a city, state, and geographical coordinates.

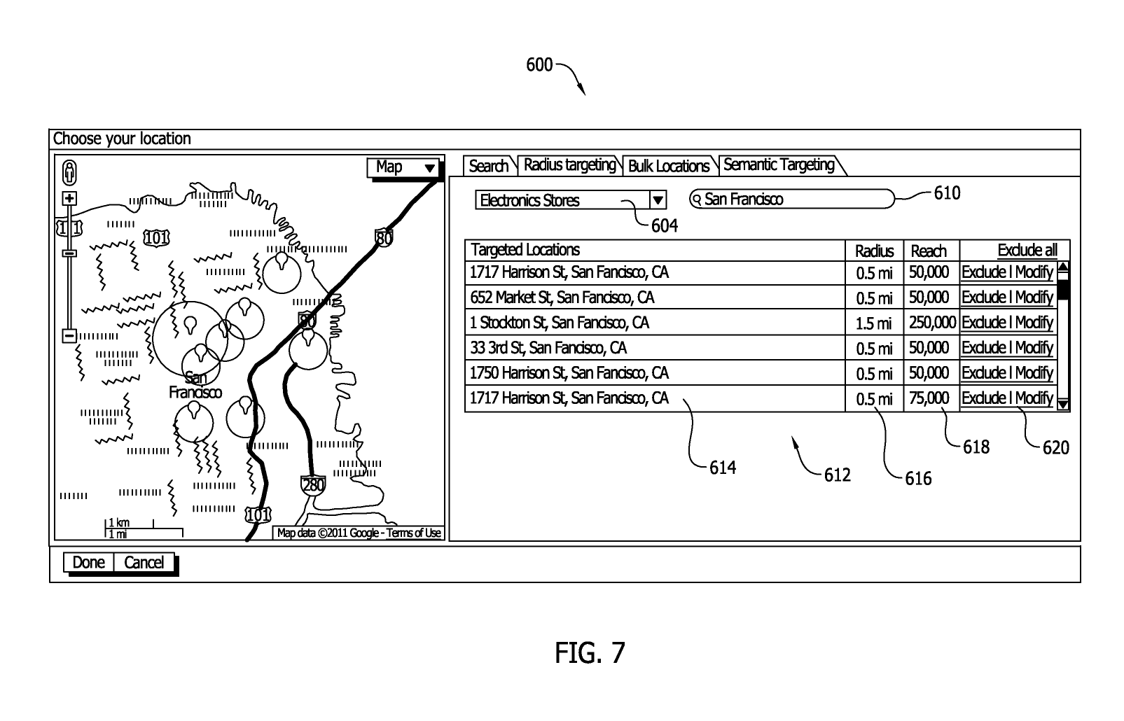

FIG. 7 is a screen capture of online content provider interface 600 in accordance with an example embodiment of the present disclosure. In the example embodiment, interface 600 includes a window 612, which indicates an address column 614, a selectable radius column 616, a reach column 618 that lists an estimate of online content recipients within the selected radius, and an edit column 620 for selecting options for editing the selections of the locations to which directed communications will be sent. Additionally, map area 608 displays graphically, the selected location using pins and the selected radii using a semi-transparent circle. If other shapes than circles (using a radius) are designated, for example, but not limited to, political boundaries, or neighborhoods, the area within the boundaries are indicated using the semi-transparent highlighting.

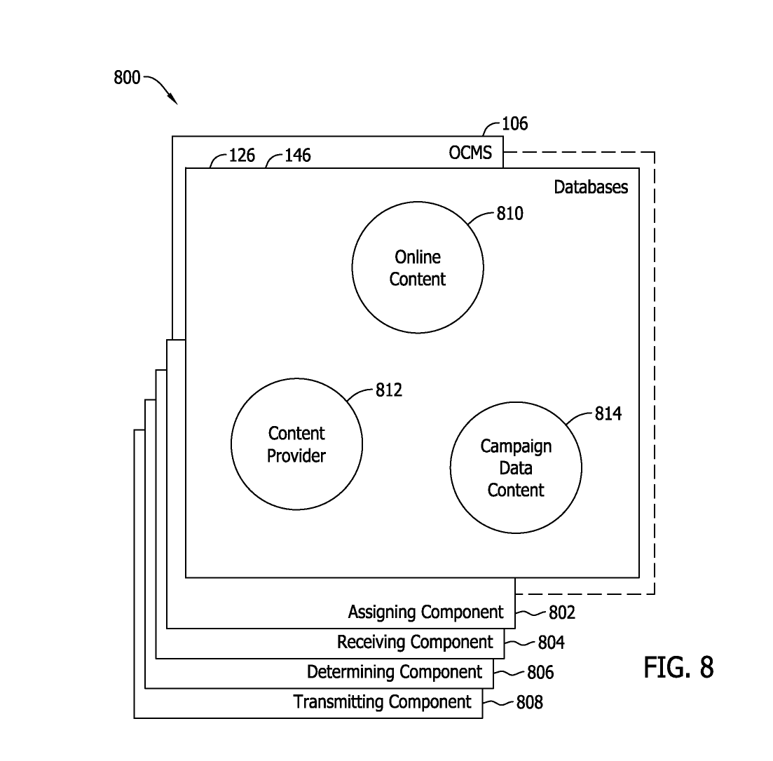

FIG. 8 is a diagram 800 of components of one or more example computing devices, for example computing device 500 (shown in FIG. 5) that may be used in environment 100 (shown in FIG. 1).

One or more of computing devices 500 (shown in FIG. 5) may form at least a portion of online content management system (OCMS) 106 or customer computing device 108 (both shown in FIG. 1). FIG. 8 further shows a configuration of databases 126 and 146 (shown in FIG. 1). Databases 126 and 146 are coupled to several separate components within OCMS 106, content provider data processing system 112, and customer computing device 108, which perform specific tasks.

OCMS 106 includes an assigning component 802 for assigning one or more identifications based on the semantic descriptions to each of a plurality of online content locations using one or more features associated with a respective one of the online content locations. OCMS 106 also includes a receiving component 804 for receiving a selection of one or more of the assigned identifications and a physical location of the associated online content locations. OCMS 106 additionally includes a determining component 806 for determining at least one of a physical location of an online content recipient, and an intended location of the online content recipient. OCMS 106 further includes a transmitting component 808 for transmitting an online content item to the online content recipient when the online content recipient is within a specified distance from any of the selected online content locations.

In an exemplary embodiment, databases 126 and 146 are divided into a plurality of sections, including but not limited to, an online content section 810, a content provider section 812, and a campaign data section 814. These sections within database 126 and 146 are interconnected to update and retrieve the information as required. Online content section 810 may include information including, for example, online content, online content layout options, online content layouts, and online content extension modules. Content provider section 812 may include information including, for example, geographic regions of interest of the content provider 102. Campaign data section 814 may include information including, for example, various ad groups and ad campaign parameters that are used to control distribution of online content.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the disclosure or its features may have different names, formats, or protocols. Further, the system may be implemented via a combination of hardware and software, as described, or entirely in hardware elements. Also, the particular division of functionality between the various system components described herein is merely one example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 117, 502, 552 including RAM memory, ROM memory, EPROM memory, EEPROM memory, and non-volatile RAM (NVRAM) memory. The above memory types are examples only, and are thus not limiting as to the types of memory usable for storage of a computer program.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. However, any database may be used that enables the systems and methods described herein.

As will be appreciated based on the foregoing specification, the above-described embodiments of the disclosure may be implemented using computer programming or engineering techniques including computer software, firmware, hardware or any combination or subset thereof, wherein the technical effect is one or more of (a) assigning one or more identifications based on the semantic descriptions to each of the plurality of online content locations using one or more features associated with a respective one of the online content locations, (b) receiving a selection of one or more of the assigned identifications and a physical location of the associated online content locations, (c) determining at least one of a physical location of an online content recipient, and an intended location of the online content recipient, and (d) transmitting an online content item to the online content recipient when the online content recipient is within a specified distance from any of the selected online content locations. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays (FPGAs), programmable array logic, programmable logic devices (PLDs) or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method of serving online content using a semantic description of a feature that is common to a plurality of online content locations, the method implemented using a computing device in communication with a memory, the method comprising:
assigning one or more identifications based on the semantic descriptions to each of the plurality of online content locations using one or more features associated with a respective one of the online content locations;
receiving, by the computing device, a selection of one or more of the assigned identifications and a physical location of the associated online content locations;
determining, by the computing device, at least one of a physical location of an online content recipient, and an intended location of the online content recipient; and
transmitting an online content item to the online content recipient when the online content recipient is within a specified distance from any of the selected online content locations.

2. The method of claim 1, further comprising categorizing the online content locations as particular types using at least one of a physical location of an online content recipient, and an intended location of the online content recipient.

3. The method of claim 2, wherein categorizing the online content locations as particular types comprises categorizing the online content locations as particular types that include at least one of store locations, local listings, travel destinations, landmarks, neighborhoods, and local demographics.

4. The method of claim 2, wherein categorizing the online content locations as local listings comprises categorizing the online content locations that include at least one of shopping malls, sports arenas, and colleges.

5. The method of claim 2, wherein categorizing the online content locations comprises wherein categorizing the online content locations that include at least one of restaurants, electronic stores, supermarkets, and museums.

6. The method of claim 1, further comprising determining the specified distance using a geo-serving system to determine a distance between the at least one of a physical location of an online content recipient and an intended location of the online content recipient and any of the selected online content locations.

7. The method of claim 1, further comprising determining the specified distance using cellular triangulation.

8. The method of claim 1, wherein determining an intended location of the online content recipient comprises determining an intended location of the online content recipient using a destination of a search request requested by the online content recipient.

9. The method of claim 1, wherein determining an intended location of the online content recipient comprises matching a categorized online content locations type with a navigation search request term requested by the online content recipient.

10. The method of claim 1, wherein determining an intended location of the online content recipient comprises determining a plurality of intended locations of the online content recipient along a path of driving directions between the physical location of the online content recipient and a destination of a search request requested by the online content recipient.

11. The method of claim 1, wherein determining a physical location of an online content recipient comprises determining a physical location of an online content recipient using a location function of a handheld device collocated with the online content recipient.

12. A computer system comprising:
a processor; and
a computer-readable storage device having encoded thereon computer readable instructions that when executed by the processor cause the processor to:
assign one or more identifications based on the semantic descriptions to each of the plurality of online content locations using one or more features associated with a respective one of the online content locations;
receive a selection of one or more of the assigned identifications and a physical location of the associated online content locations;
determine at least one of a physical location of an online content recipient, and an intended location of the online content recipient; and
transmit an online content item to the online content recipient when the online content recipient is within a specified distance from any of the selected online content locations.

13. The system of claim 12, wherein the computer readable instructions when executed by the processor cause the processor to categorize the online content locations using at least one of a physical location of an online content recipient, and an intended location of the online content recipient.

14. The system of claim 12, wherein the computer readable instructions when executed by the processor cause the processor to categorize the online content locations as particular types wherein the types include at least one of local listings, landmarks, and demographics.

15. The system of claim 12, wherein the computer readable instructions when executed by the processor cause the processor to determine the specified distance using a geo-serving system to determine a distance between the at least one of a physical location of an online content recipient and an intended location of the online content recipient and any of the selected online content locations.

16. The system of claim 12, wherein the computer readable instructions when executed by the processor cause the processor to determine an intended location of the online content recipient using a destination of a search request requested by the online content recipient.

17. The system of claim 12, wherein the computer readable instructions when executed by the processor cause the processor to match a categorized online content locations type with a navigation search request term requested by the online content recipient.

18. A computer-readable storage device, having computer-executable instructions embodied thereon, wherein when executed by at least one processor, the computer-executable instructions cause the processor to:
assign one or more identifications based on the semantic descriptions to each of the plurality of online content locations using one or more features associated with a respective one of the online content locations;
receive a selection of one or more of the assigned identifications and a physical location of the associated online content locations;
determine at least one of a physical location of an online content recipient, and an intended location of the online content recipient; and
transmit an online content item to the online content recipient when the online content recipient is within a specified distance from any of the selected online content locations.

19. The computer-readable storage device of claim 18, wherein the computer-executable instructions further cause the processor to determine a plurality of intended locations of the online content recipient along a path of driving directions between the physical location of the online content recipient and a destination of a search request requested by the online content recipient.

20. The computer-readable storage device of claim 18, wherein the computer-executable instructions further cause the processor to determine a physical location of an online content recipient using a location function of a handheld device collocated with the online content recipient.
